(19) United States
(12) Patent Application Publication
(10) Pub. No.: US 2024/0095359 A1
(43) Pub. Date: Mar. 21, 2024

(54) AUDITING AND SECURING PROGRAM CALLS

(71) Applicant: International Business Machines Corporation, Armonk, NY (US)

(72) Inventors: Dong Hui Liu, Beijing (CN); Peng Hui Jiang, Beijing (CN); Jing Lu, Beijing (CN); Jia Yu, BEIJING (CN); Jun Su, Beijing (CN); Xiao Yan Tang, BEIJING (CN); Yong Yin, BEIJING (CN)

(73) Assignee: International Business Machines Corporation, Armonk, NY (US)

(21) Appl. No.: 17/948,400

(22) Filed: Sep. 20, 2022

(51) Int. Cl. G06F 21/56; G06F 21/51

(52) U.S. Cl. CPC G06F 21/566; G06F 21/51; G06F 2221/033

(57) ABSTRACT

An embodiment includes generating a caller list of callers that issue requests for calling a designated program at runtime. The embodiment also includes generating an authorized caller list of authorized callers allowed to call the designated program, wherein the authorized callers are selected from among callers on the caller list. The embodiment also includes generating an authorization key for each of the authorized callers that the designated program will require as a condition for completing call requests.

### BACKGROUND

The present invention relates generally to a method, system, and computer program product for securing program execution environments. More particularly, the present invention relates to a method, system, and computer program product for auditing and securing program calls.

It is desirable that electronic devices such as computers and mobile telephones should wherever possible minimize their requirements for memory. To further the efficient usage of a device's memory resources, amongst other advantages, certain functions and modules which may be common to a number of application programs may be stored in the form of a library so that these functions and modules are only stored once and not replicated in each of the application programs with which they are to be used. Such libraries will normally reside in storage memory, only being loaded into program memory when their functions are required by an application program.

A program call refers to the process of a program causing a library, such as a dynamic link library (DLL), to be loaded from storage memory to program memory so that the program may execute some function of the library. A program call may also be referred to as a function call. In response to a program call, the entire DLL file may be loaded, or only a subset of the functions in the file (for example, only those functions linked to by the calling program). As used herein, the action of loading, or preloading, a DLL should be construed as covering both. The contents of these libraries are selectively called and linked to the application programs when they are loaded or run. When this process is followed, the same block of library code can be shared between several tasks to run on the device rather than each task containing copies of the routines it uses.

These libraries link dynamically with the application programs as the application programs are run and hence the libraries are commonly known as dynamic link libraries (DLLs). Most modern computer operating systems provide one or more DLL facilities that enable certain application program procedures and functions to be provided in the form of one or more libraries that are separate from the application programs that execute on the computing device. Typically, an application program is dynamically linked to one or more libraries at run-time, so that the application program can call one or more of the procedures and functions that are exported by the libraries.

DLLs provide, therefore, a manner in which application programs can be provided in modular format so that certain functionality can be shared, updated, and reused more easily. They also help reduce memory overhead when several applications use the same functionality at the same time, because although each application is provided with a copy of the data, each can share the code representing that functionality.

### SUMMARY

The illustrative embodiments provide for auditing and securing program calls. An embodiment includes generating a caller list of callers that issue requests for calling a designated program at runtime. The embodiment also includes generating an authorized caller list of authorized callers allowed to call the designated program, where the authorized callers are selected from among callers on the caller list. The embodiment also includes generating an authorization key for each of the authorized callers that the designated program will require as a condition for completing call requests. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a cloud computing environment according to an embodiment of the present invention;

FIG. 2 depicts abstraction model layers according to an embodiment of the present invention;

FIG. 3 depicts a block diagram of an example service infrastructure in accordance with an illustrative embodiment;

FIG. 4 depicts a block diagram of an example program security application in accordance with an illustrative embodiment;

FIG. 5 depicts a block diagram of an example auditing module in accordance with an illustrative embodiment;

FIG. 6 depicts a block diagram of an example runtime environment for a dynamic analysis module in accordance with an illustrative embodiment;

FIG. 7 depicts a block diagram of an example environment for a credentialing module in accordance with an illustrative embodiment; and

FIG. 8 depicts a flowchart of an example process for auditing and securing program calls in accordance with an illustrative embodiment.

### DETAILED DESCRIPTION

Shared libraries help reduce memory overhead by providing functionality that can be accessed by multiple different programs through the use of program calls. However, program calls have also been exploited by attacks on computer systems that involve altering source code or introducing malicious programs.

These types of exploits have led to a growing interest in security audits of key business programs. Maintaining isolation of such programs is important for maintaining security and control of important systems and sensitive data. However, performing such audits has been challenging for many reasons. In some cases, auditors may lack the knowledge or background to have a sufficiently detailed understanding of the source code of such programs. Also, presently available application security inspection tools, including tools for scanning source code, are not capable of detecting every possible security threat.

Static analysis and dynamic analysis are examples of techniques that have been proposed as program auditing tools. Static analysis of a program (caller) may be used to try to determine libraries the program calls based on the program's import and export tables. Thus, static analysis is of limited usefulness as it is only useful for identifying callees of a designated caller. Using static analysis to try to identify all callers of a designated callee would require analyzing every program on, or that has access to, a host system. As a result, finding callers for a designated callees would require an enormous workload even if there is only one or a few callee programs of interest.

Dynamic analysis can be used to identify callers of a designated callee by tracking calls that occur at runtime. However, dynamic analysis may miss callers that do not happen to call during the audit runtime. For example, some callers may only be executed or issue calls very infrequently and therefore have gaps between calls that are long enough to allow the caller to be missed during an audit runtime.

Aspects of the present disclosure address the deficiencies described above by providing a method to audit call relationships of key programs and reduce the security threat of illegal calls. The present disclosure recognizes that the ability to identify call relationships of programs and shared libraries may be significantly improved by combining static analysis and dynamic analysis as described herein. The illustrative embodiments are based on recognition of the common practice of putting related business logic in the same library or organizing related programs in parts of a file structure that have identifiable common characteristics. Also, key business programs may have other similar characteristics, such as similar security policies or similar business relevance.

This insight is leveraged in illustrative embodiments that provide for auditing and securing program calls. In some embodiments, a user designates a program to be audited. The audit includes identifying callers and/or callees, where callers are other programs that make function calls to the designated program and callees are other programs to which the designated program makes function calls. In some such embodiments, a dynamic analysis is first performed on the designated program to identify at least some of the callers of the designated program. The results of the dynamic analysis form a preliminary caller list.

In some embodiments, the preliminary caller list is processed using a similarity analysis. The similarity analysis involves identifying other programs that are similar in some way to the caller programs on the preliminary caller list. In some embodiments, the similarity analysis is performed for each program on the preliminary caller list. In some such embodiments, for each program, the similarity analysis identifies similar programs, where the similarity is based on characteristics and criteria previously designated by a user, such as a system administrator or system auditor. For example, similarity may be determined based on whether programs have the same security policy or programs that have some similarity in their security policies, such as programs that are all accessible by users in a particular access-control group. Another example may include programs that share some business relevance, which may be programs that a user has specified as sharing business relevance. A further example may include programs that are located in the same path, same library, same dataset, or have similar dataset names as defined by a user.

In an illustrative embodiment, the similarity analysis identifies programs that are similar to the programs identified by the dynamic analysis. The similar programs form a candidate caller list. This candidate caller list is therefore a list of programs that are similar to caller programs identified by the dynamic analysis and have the potential to be caller programs that were not identified by the dynamic analysis.

In an illustrative embodiment, a static analysis is then performed on each of the programs on the candidate caller list. The static analysis is performed to detect any remaining callers that may not have been detected by the dynamic analysis. Since the dynamic analysis and similarity analysis have been performed before the static analysis, the static analysis may be used to detect callers without requiring static analysis of every program on a host system or that has access to a host system. As a result, finding callers for a designated callee requires a significantly reduced workload compared to prior processes in which static analysis would have to have been performed on every program on a host system or that has access to a host system.

In an illustrative embodiment, once the static analysis is complete, the supplemental caller list is combined with the preliminary caller list, resulting in a final caller list. In some embodiments, the final caller list is then compared to a policy table. In some such embodiments, legitimate calls may be distinguished from unauthorized calls by comparing the callee/caller pair to the access control table.

In some embodiments, the final caller list is used to define policies for access between programs. In some such embodiments, an entry in an access control table is generated upon determining that the call is legitimate. For example, in some embodiments, the call may be evaluated to determine whether the call is one that is expected. On the other hand, the call may be evaluated to determine whether any core services have access risks caused by that particular call. In some embodiments, the resulting access control table may be used as a basis for determining which callee/caller pairs should be assigned access credentials to allow for continued access and which callee/caller pairs should not be assigned access credentials to prevent future access.

In an illustrative embodiment, credentials are added to callee/caller programs using add_callee and add_caller compiler options. When add_callee is used to compile a callee program, the compiler will request a callee key from a credential storage. When add_caller is used to compile a caller program, the compiler identifies caller key(s) listed in a key symbol table, where the caller key(s) are credentials that the caller program will need to access its authorized callee programs.

In some embodiments, a constructed key may be generated for the caller, where the constructed key may include the key corresponding to the callee and memory location information corresponding to a location in memory where the caller is stored. In some embodiments, one or more callees that receive function calls from a caller may actively construct a new globally unique constructed key that may include the memory location information corresponding to a location in memory where the caller is stored and the key corresponding to the respective callee.

Specifically, information such as the key corresponding to the callee data and the memory location information corresponding to a location in memory where the caller is stored may be filled into a constructed key structure and may be encoded to arrive at the constructed key. In some embodiments, the constructed key may be represented in binary form when populated in the constructed key structure. The binary representation may be converted to a visible character string, for example, ASCII characters, by encoding the populated binary constructed key structure using BASE64, Punycode or UrlEncode, for example. However, the constructed key is not limited to any specific type of representation or format and any suitable type of representation or format may be utilized for the constructed key. Moreover, the binary form of the constructed key may also be directly utilized as the constructed key.

In addition to including the key corresponding to the callee and the memory location information for the caller, the constructed key may further include a constructed key symbol, a constructed key check field, a Cyclic Redundancy Check (CRC) check value (or a Secure Hash Algorithm (SHA) or Message Digest Algorithm 5 (MD5) value), an identity of the caller, a version number of the constructed key and/or other custom information.

In the illustrated embodiment, the compiler requests the callee key from an access-control information database, such as a Resource Access Control Facility (RACF) (RACF is a registered trademark of International Business Machines Corporation in the United States and elsewhere abroad). Thereafter, any program that calls the callee program must have the exact callee key. Thus, for example if the caller program is authorized to call the callee program, the compiler provides the caller program with the caller key that corresponds with the callee key provided to the callee program. A binder will then bind the caller and callee together, including static dynamic links.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

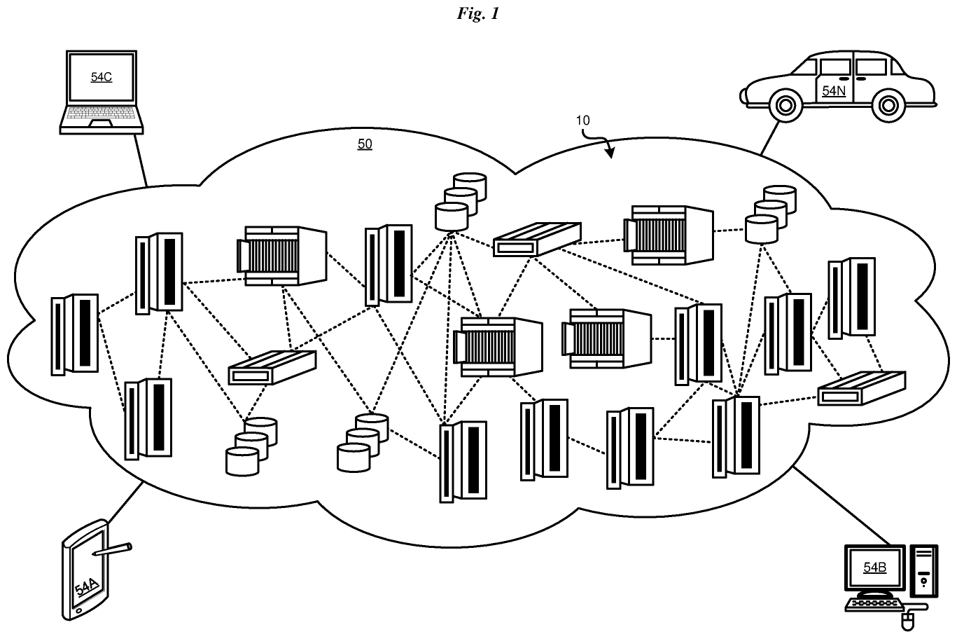

With reference to FIG. 1, this figure illustrates cloud computing environment 50. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

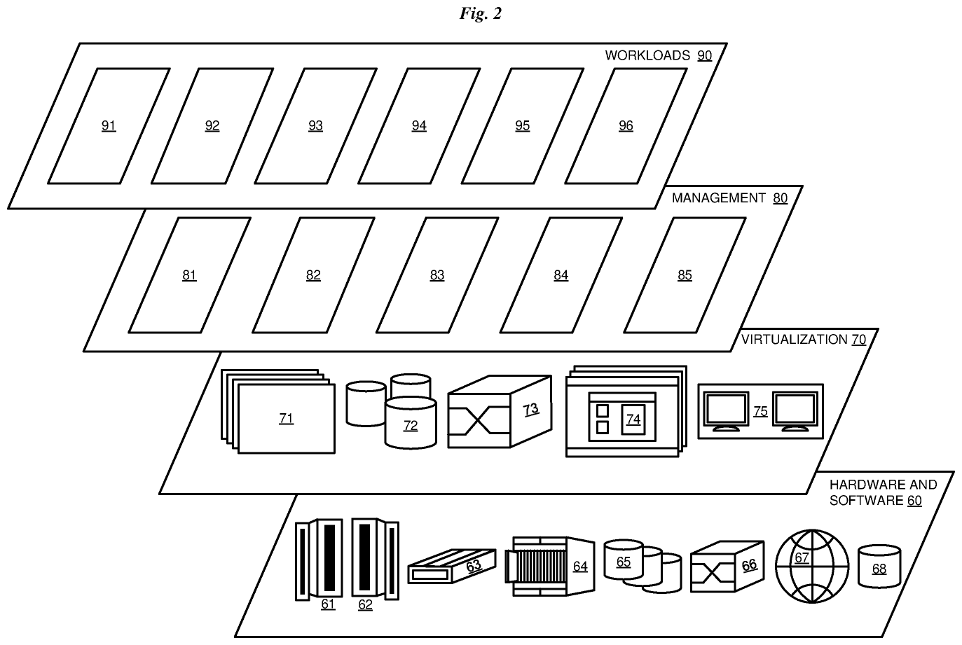

With reference to FIG. 2, this figure depicts a set of functional abstraction layers provided by cloud computing environment 50 (FIG. 1). It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and in the context of the illustrated embodiments of the present disclosure, various workloads and functions 96 for program security processing. In some embodiments, the workloads and functions 96 also works in conjunction with other portions of the various abstraction layers, such as those in hardware and software 60, virtualization 70, and management 80 to accomplish the various purposes of the disclosed embodiments.

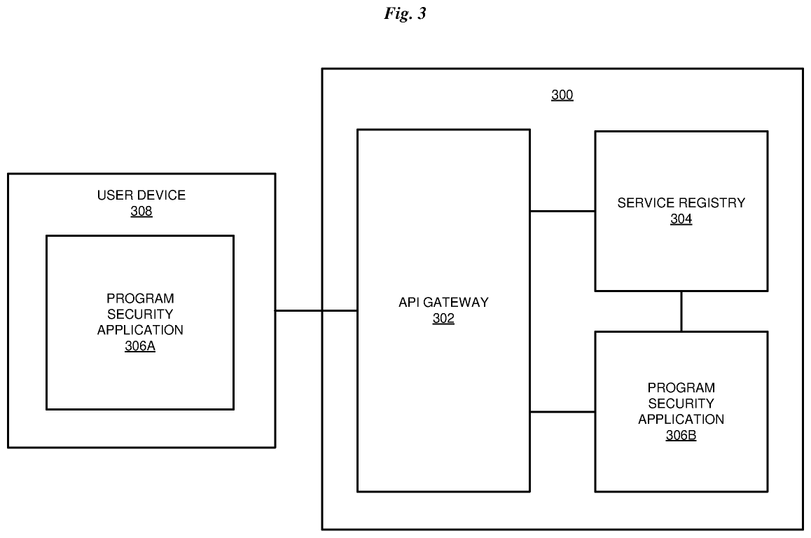

With reference to FIG. 3, this figure depicts a block diagram of an example service infrastructure 300 in accordance with an illustrative embodiment. In the illustrated embodiment, the infrastructure 300 is in communication with a user device 308 that includes a program security application 306A in accordance with an illustrative embodiment. Alternatively, the program security application resides in the service infrastructure as program security application 306B, for example as workloads and functions 96 for program security processing of FIG. 2 in a cloud-based system that may be shared by multiple users, for example across a department, organization, or enterprise. In some embodiments, some or all of the program security application functionality described herein is distributed among a plurality of systems, for example distributed between program security application 306A of the user device 308 and program security application 306B of the infrastructure 300. For the sake of simplicity, program security application 306 refers to any of these and other embodiments, and therefore includes program security application 306A, program security application 306B, and program security application 306A and 306B collectively.

In the illustrated embodiment, the service infrastructure 300 provides services and service instances to a user device 308. User device 308 communicates with service infrastructure 300 via an application programming interface (API)js gateway 302. In various embodiments, service infrastructure 300 and its associated program security application 306 serve multiple users and multiple tenants. A tenant is a group of users (e.g., a company) who share a common access with specific privileges to the software instance. Service infrastructure 300 ensures that tenant specific data is isolated from other tenants.

In some embodiments, user device 308 connects with API gateway 302 via any suitable network or combination of networks such as the Internet, etc. and use any suitable communication protocols such as Wi-Fi, Bluetooth, etc. Service infrastructure 300 may be built on the basis of cloud computing. API gateway 302 provides access to client applications like program security application 306. API gateway 302 receives service requests issued by client applications, and creates service lookup requests based on service requests. As a non-limiting example, in an embodiment, the user device 308 includes software, such as a web browser or security software that communicates with the program security application 306, including allowing a user to input information for the program security application 306 or view information output by the program security application 306.

In the illustrated embodiment, service infrastructure 300 includes a service registry 304. In some embodiments, service registry 304 looks up service instances of program security application 306 in response to a service lookup request such as one from API gateway 302 in response to a service request from user device 308. For example, in some embodiments, the service registry 304 looks up service instances of program security application 306 in response to requests from the user device 308 related to program security.

In some embodiments, the service infrastructure 300 includes one or more instances of the program security application 306. In some such embodiments, each of the multiple instances of the program security application 306 run independently on multiple computing systems. In some such embodiments, program security application 306, as well as other service instances of program security application 306, are registered in service registry 304.

In some embodiments, service registry 304 maintains information about the status or health of each service instance including performance information associated each of the service instances. For example, such performance information may include several types of performance characteristics of a given service instance (e.g., cache metrics, etc.). In some embodiments, the extended service registry 304 ranks service instances based on their respective performance characteristics, and selects top-ranking service instances for classification requests. In some such embodiments, in the event that a service instance becomes unresponsive or, unhealthy, the service registry will no longer provide its address or information about this service instance to other services.

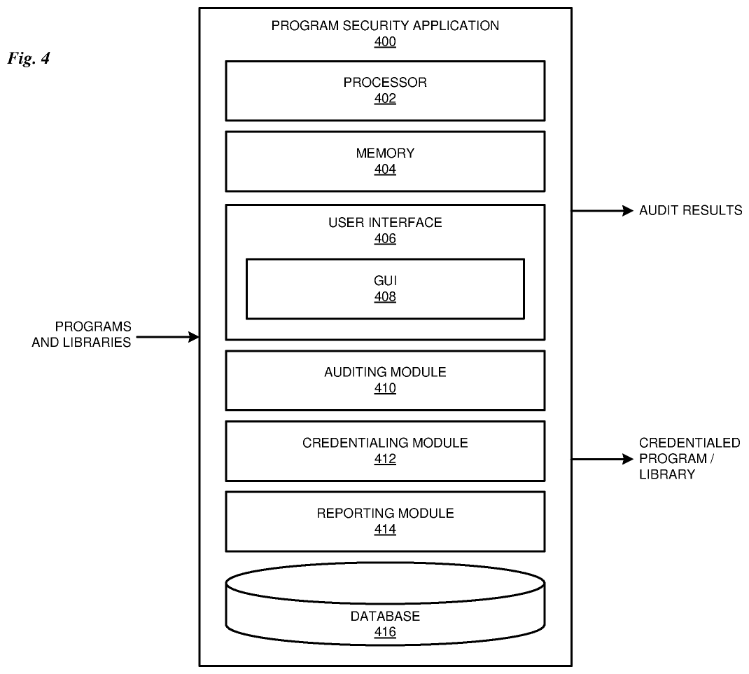

With reference to FIG. 4, this figure depicts a block diagram of an example program security application 400 in accordance with an illustrative embodiment. In a particular embodiment, the program security application 400 is an example of the program security application 306 of FIG. 3.

In some embodiments, the program security application 400 includes a processor 402, memory 404, a user interface 406 that includes a graphical user interface (GUI) 408, an auditing module 410, a credentialing module 412, a reporting module 414, and a database 416. In alternative embodiments, the program security application 400 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the processing unit (“processor”) 402 performs various computational and data processing tasks, as well as other functionality. The processing unit 402 is in communication with memory 404. In some embodiments, the memory 404 comprises one or more computer readable storage media with program instructions collectively stored on the one or more computer readable storage media, with the program instructions being executable by one or more processors 402 to cause the one or more processors 402 to perform operations described herein.

In the illustrated embodiment, the user interface 406 provides a point of human interaction with the program security application 400. For example, in the illustrated embodiment, the user interface 406 communicates with a user device 418 via a network, such as the Internet or a private network. The user device 418 may be any type of user computing device, for example the personal digital assistant (PDA) or cellular telephone 54A, desktop computer 54B, laptop computer 54C, and/or automobile computer system 54N shown in FIG. 1, and may include such things as a display, touch screen, keyboard, processor, memory, network interface, and other known components of such computing devices.

In the illustrated embodiment, the auditing module 410 is configured to identify call relationships between programs that call or accept calls to shared functions at runtime, such as an executable file or a DLL file. In some embodiments, a user may input, via the user interface 406, an indication of a designated program to be audited. The auditing module 410 will then perform an auditing routine that generates a caller list for the designated program. In some embodiments, the auditing module 410 generates a caller list according to embodiments disclosed herein. The resulting “caller list” is a list of other programs that issue function calls to the designated program at runtime. For example, the user may designate a DLL file, and in response the auditing module 410 will generate a list of programs that issue a function call to the designated DLL file.

In some embodiments, the auditing module 410 is configured to generate an authorized caller list. The “authorized caller list” is a list of programs that have permission to issue a function call to the designated program. In some embodiments, the auditing module 410 presents the caller list to the user via the GUI 408. The user may then review the caller list and select programs on the caller list that are authorized to issue function calls to the designated program. The user selections are provided as inputs to the auditing module 410, which then uses these inputs to generate the authorized caller list. In some embodiments, the auditing module 410 transmits the authorized caller list to the credentialing module 412. In some embodiments, the auditing module 410 stores the authorized caller list in the database 416.

In the illustrated embodiment, the credentialing module 412 is configured to receive the authorized caller list from the auditing module 410 or retrieve the authorized caller list from the database 416. In some embodiments, the credentialing module 412 generates credentials for each of the programs on the authorized caller list. For example, in some embodiments, the credentialing module 412 is configured to generate a digital signature for each of the authorized callers. In some such embodiments, the digital signature is based upon a private key held by the designated program. In some embodiments, the digital signature is based upon a memory address of a save location of the authorized caller.

In the illustrated embodiment, the reporting module 414 may use the output of the auditing module 410 to generate an audit report. In some embodiments, the audit report may be output to a user or transmitted to another program. In some embodiments, the reporting module 414 may format the output of the auditing module 410 to comply with input requirements of another program to which the data is being transmitted. For example, in some embodiments, reporting module 414 may generate a JavaScript Object Notation (JSON) or Extensible Markup Language (XML) file that includes the output of the auditing module user device 410.

In the illustrated embodiment, the database 416 is stored on a computer readable storage medium and is used to store persistent data for the program security application 400. For example, the caller list and authorized caller list may be stored in the database 416. The database 416 may also be configured to serve as a key store that stores encrypted versions of credentials issued by the credentialing module 412.

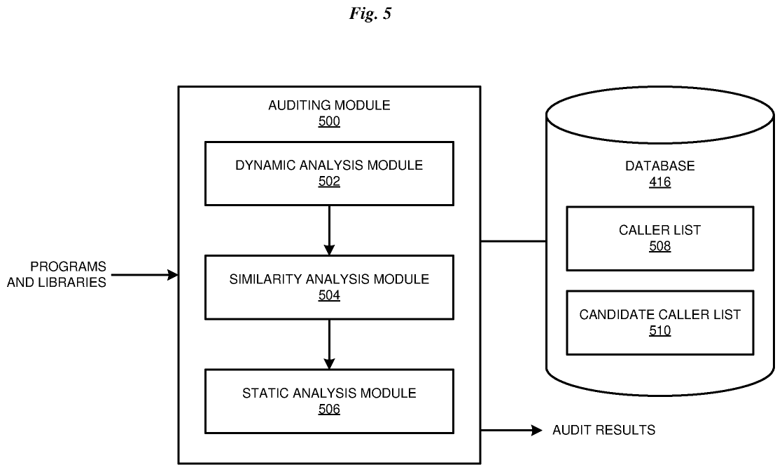

With reference to FIG. 5, this figure depicts a block diagram of an example auditing module 500 in accordance with an illustrative embodiment. In a particular embodiment, auditing module 500 is an example of auditing module 410 of FIG. 4.

In the illustrated embodiment, the auditing module 500 includes a dynamic analysis module 502, a similarity analysis module 504, and a static analysis module 506. In alternative embodiments, the auditing module 500 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

The auditing module 500 is configured to identify the call relationships of key business programs to help isolate the key business programs in a security audit and help reduce the security threat of illegal calls. In the illustrated embodiment, the auditing module 500 accomplishes this by combining static analysis and dynamic analysis to identify call relationships between programs. Static analysis may be used alone for known application libraries such as DLLs in which static analysis can identify call relationships from a program's import and export tables. However, static analysis alone is only useful for identifying callees for a designated caller, unless all programs on a system are analyzed to find callers for a designated callee. This means an enormous workload even if there is only one or a few callee programs of interest. Dynamic analysis tracks calls at runtime and if used alone may miss calls from programs that do not call very frequently or do not happen to call during the auditing period.

The illustrated embodiment is based on recognition of the common practice of putting related business logic in the same library or organizing related programs in parts of a file structure that have identifiable common characteristics. Also, key business programs may have other similar characteristics, such as similar security policies or similar business relevance. This insight is leveraged in the illustrated embodiment that starts with a dynamic analysis module 502 that performs a dynamic analysis on a designated program. The results of the dynamic analysis form a preliminary caller list 508 that is stored on the database 416. The preliminary caller list 508 may be incomplete for reasons discussed above, so the similarity analysis module 504 generates a candidate caller list 510 by comparing available programs to the callers detected by the dynamic analysis module 502. This allows the static analysis module 506 to perform static analysis on just the candidate caller list 510 rather than on every program on the system (as typically would be done if static analysis is performed alone). The static analysis module 506 analyzes the candidate callers on the candidate caller list 510 with static analysis, resulting in a supplemental caller list that includes callers that did not issue a call during the dynamic analysis by the dynamic analysis module 502 (and may have been missed if dynamic analysis was performed alone).

Once the static analysis is complete, the supplemental caller list is combined with the preliminary caller list generated by the dynamic analysis module 502 resulting in a final caller list 508. In some embodiments, this information is then compared to a policy table or is used to define policies for access between programs. Legitimate calls may be verified by comparing the callee/caller pair to an access control table, or an entry in an access control table may be generated upon determining that the call is legitimate. For example, in some embodiments, the call may be evaluated to determine whether a call is one that is expected. On the other hand, a call may be evaluated to determine whether any core services have access risks caused by a particular call. In some embodiments, the resulting access control table may be used as a basis for determining which callee/caller pairs should be assigned access credentials (e.g., by the credentialing module 412 of FIG. 4) to allow for continued access and which callee/caller pairs should not be assigned access credentials to prevent future access.

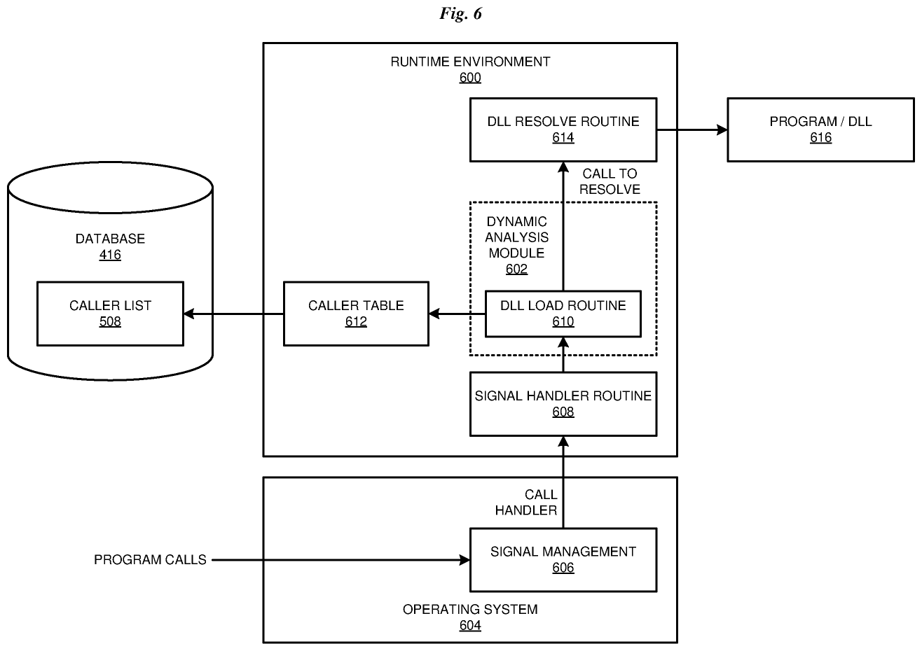

With reference to FIG. 6, this figure depicts a block diagram of an example runtime environment 600 for a dynamic analysis module 602 in accordance with an illustrative embodiment. In a particular embodiment, dynamic analysis module 602 is an example of dynamic analysis module 502 of FIG. 5.

In the illustrated embodiment, the runtime environment 600 is part of, or in communication with, an operating system 604 that includes signal management 606. The runtime environment 600 includes a signal handler routine 608, a DLL load routine 610, a caller table 612, a DLL resolve routine 614. In alternative embodiments, the runtime environment 600 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the operating system 604 includes signal management 606 that monitors program calls and notifies a signal handler routine 608 as calls are received. The signal handler routine 608 notifies a DLL load routine 610 to load the requested DLL into program memory and a DLL resolve routine 614 to resolve symbols if necessary before linking the DLL to a caller program/DLL 616. In the illustrated embodiment, the dynamic analysis module 602 instructs the DLL load routine 610 to also write caller information to a caller table 612 if the call is associated with a designated program under analysis. The callers for the designated program are written to the database 416 as a caller list 508, where the caller list may be further processed as described in connection with FIG. 5.

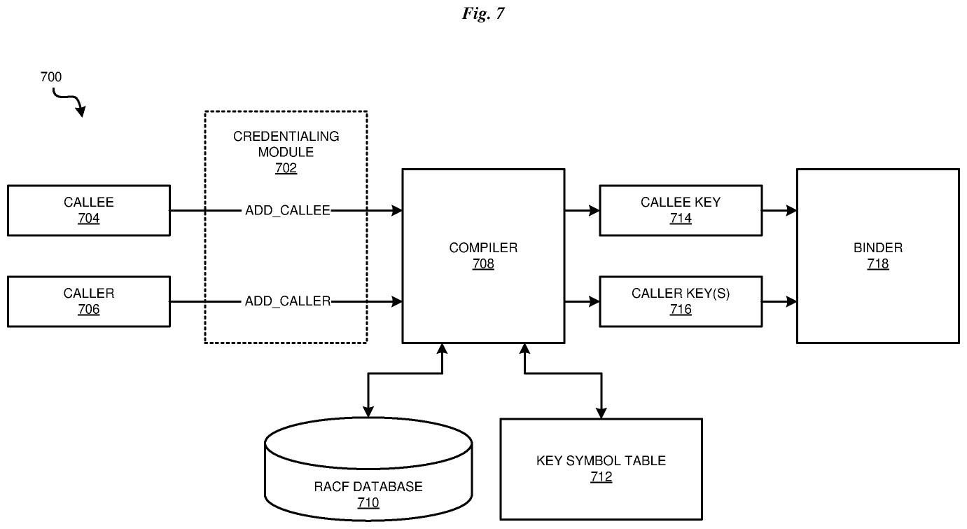

With reference to FIG. 7, this figure depicts a block diagram of an example environment 700 for a credentialing module 702 in accordance with an illustrative embodiment. In a particular embodiment, credentialing module 702 is an example of credentialing module 412 of FIG. 4.

In the illustrated embodiment, the environment 700 includes a credentialing module 702, a compiler 708, and a binder 718. In alternative embodiments, the environment 700 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the credentialing module 702 enhances a compiler with new options: add_callee and add_caller. When add_callee is used to compile a callee program 704, the compiler 708 will request a callee key 714 from a credential storage. When add_caller is used to compile a caller program 706, the compiler 708 identifies caller key(s) 716 listed in a key symbol table 712, where the caller key(s) 716 are credentials that the caller program 706 will need to access its authorized callee programs.

In some embodiments, a constructed key may be generated for the caller, where the constructed key may include the key corresponding to the callee and memory location information corresponding to a location in memory where the caller is stored. In some embodiments, one or more callees that receive function calls from a caller may actively construct a new globally unique constructed key that may include the memory location information corresponding to a location in memory where the caller is stored and the key corresponding to the respective callee.

Specifically, information such as the key corresponding to the callee data and the memory location information corresponding to a location in memory where the caller is stored may be filled into a constructed key structure and may be encoded to arrive at the constructed key. In some embodiments, the constructed key may be represented in binary form when populated in the constructed key structure. The binary representation may be converted to a visible character string, for example, American Standard Code for Information Interchange (ASCII) characters, by encoding the populated binary constructed key structure using BASE64, Punycode or UrlEncode, for example. However, the constructed key is not limited to any specific type of representation or format and any suitable type of representation or format may be utilized for the constructed key. Moreover, the binary form of the constructed key may also be directly utilized as the constructed key.

In addition to including the key corresponding to the callee and the memory location information for the caller, the constructed key may further include a constructed key symbol, a constructed key check field, a Cyclic Redundancy Check (CRC) check value (or a Secure Hash Algorithm (SHA) or Message Digest Algorithm 5 (MD5) value), an identity of the caller, a version number of the constructed key and/or other custom information.

In the illustrated embodiment, the compiler 708 requests the callee key from an access-control information database, such as an RACF database 710. Thereafter, any program that calls the callee program 704 must have the exact callee key 714. Thus, for example if the caller program 706 is authorized to call the callee program 704, the compiler provides the caller program 706 with the caller key 716 that corresponds with the callee key 714 provided to the callee program 704. The binder 718 will then bind the caller 706 and callee 704 together, including static dynamic links.

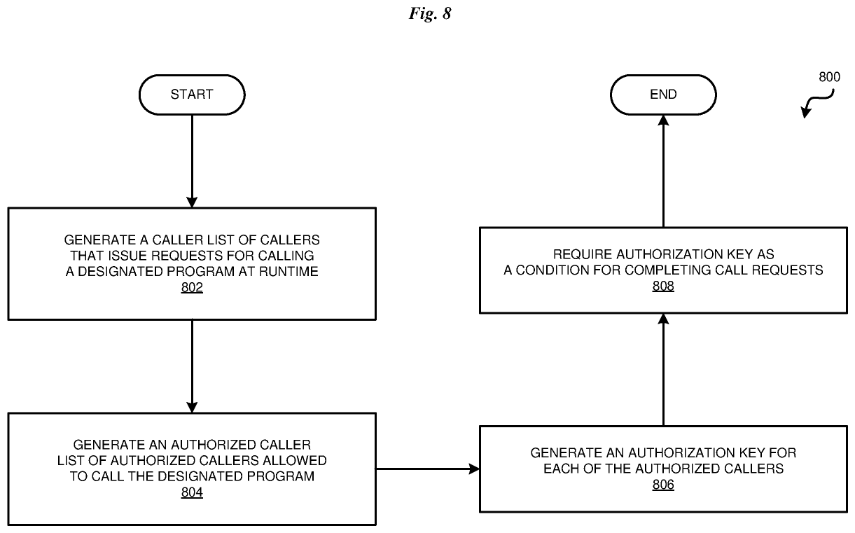

With reference to FIG. 8, this figure depicts a flowchart of an example process 800 for auditing and securing program calls in accordance with an illustrative embodiment. In a particular embodiment, the program security application 306 carries out the process 800.

In an embodiment, at block 802, the process generates a caller list of callers that issue requests for calling a designated program at runtime. In some embodiments, a user designates a program to be audited. In some such embodiments, a dynamic analysis is first performed on the designated program to identify at least some of the callers of the designated program. The results of the dynamic analysis form a preliminary caller list, which is then processed using a similarity analysis. The similarity analysis involves identifying other programs that are similar in some way to the caller programs on the preliminary caller list. In some embodiments, similarity is based on characteristics and criteria previously designated by a user, such as a system administrator or system auditor. For example, similarity may be determined based on whether programs have the same security policy or programs that have some similarity in their security policies, such as programs that are all accessible by users in a particular access-control group. Another example may include programs that share some business relevance, which may be programs that a user has specified as sharing business relevance. A further example may include programs that are located in the same path, same library, same dataset, or have similar dataset names as defined by a user. The similar programs form a candidate caller list. In some embodiments, a static analysis is then performed on each of the programs on the candidate caller list, resulting in a supplemental caller list. In some embodiments, once the static analysis is complete, the supplemental caller list is combined with the preliminary caller list, resulting in a final caller list.

Next, at block 804, the process generates an authorized caller list of authorized callers allowed to call the designated program, where the authorized callers are selected from among callers on the caller list. In some embodiments, the final caller list is compared to a policy table. In some such embodiments, legitimate calls may be distinguished from unauthorized calls by comparing the callee/caller pair to the access control table. In some embodiments, the final caller list is used to define policies for access between programs. In some such embodiments, an entry in an access control table is generated upon determining that the call is legitimate. For example, in some embodiments, the call may be evaluated to determine whether the call is one that is expected. On the other hand, the call may be evaluated to determine whether any core services have access risks caused by that particular call. In some embodiments, the resulting access control table may be used as a basis for determining which callee/caller pairs should be assigned access credentials to allow for continued access and which callee/caller pairs should not be assigned access credentials to prevent future access.

Next, at block 806, the process generates an authorization key for each of the authorized callers that the designated program will require as a condition for completing call requests. In an illustrative embodiment, credentials are added to callee/caller programs using add_callee and add_caller compiler options. When add_callee is used to compile a callee program, the compiler will request a callee key from a credential storage. When add_caller is used to compile a caller program, the compiler identifies caller key(s) listed in a key symbol table, where the caller key(s) are credentials that the caller program will need to access its authorized callee programs.

In some embodiments, a constructed key may be generated for the caller, where the constructed key may include the key corresponding to the callee and memory location information corresponding to a location in memory where the caller is stored. In some embodiments, one or more callees that receive function calls from a caller may actively construct a new globally unique constructed key that may include the memory location information corresponding to a location in memory where the caller is stored and the key corresponding to the respective callee.

Specifically, information such as the key corresponding to the callee data and the memory location information corresponding to a location in memory where the caller is stored may be filled into a constructed key structure and may be encoded to arrive at the constructed key. In some embodiments, the constructed key may be represented in binary form when populated in the constructed key structure. The binary representation may be converted to a visible character string, for example, ASCII characters, by encoding the populated binary constructed key structure using BASE64, Punycode or UrlEncode, for example. However, the constructed key is not limited to any specific type of representation or format and any suitable type of representation or format may be utilized for the constructed key. Moreover, the binary form of the constructed key may also be directly utilized as the constructed key.

In addition to including the key corresponding to the callee and the memory location information for the caller, the constructed key may further include a constructed key symbol, a constructed key check field, a Cyclic Redundancy Check (CRC) check value (or a Secure Hash Algorithm (SHA) or Message Digest Algorithm 5 (MD5) value), an identity of the caller, a version number of the constructed key and/or other custom information. In some embodiments, the compiler requests the callee key from an access-control information database, such as an RACF database.

Next, at block 808, the process implements a requirement for the authorization key as a condition for completing call requests. For example, if a caller program is authorized to call a callee program, the compiler provides the caller program with the caller key that corresponds with the callee key provided to the callee program. A binder will then bind the caller and callee together, including static dynamic links. Thereafter, any program that calls the callee program must have the exact callee key.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM) or Flash memory, a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
generating a caller list of callers that issue requests for calling a designated program at runtime;
generating an authorized caller list of authorized callers allowed to call the designated program, wherein the authorized callers are selected from among callers on the caller list; and
generating an authorization key for each of the authorized callers that the designated program will require as a condition for completing call requests.

2. The computer-implemented method of claim 1, wherein the designated program is an executable application.

3. The computer-implemented method of claim 1, wherein the designated program is a shared library file.

4. The computer-implemented method of claim 1, wherein the generating of the caller list comprises analyzing the designated program with dynamic analysis resulting in a preliminary caller list of detected callers that issue requests for calling the designated program during the dynamic analysis.

5. The computer-implemented method of claim 4, wherein the generating of the caller list further comprises generating a candidate caller list by comparing available programs to detected callers on the caller list and identifying, as candidate callers, available programs that have a preselected characteristic in common with at least one detected caller on the preliminary caller list.

6. The computer-implemented method of claim 5, wherein the preselected characteristic is selected from the group consisting of a security policy, a business relevance, a same path, a same library, and a same dataset.

7. The computer-implemented method of claim 5, wherein the generating of the caller list further comprises analyzing the candidate callers on the candidate caller list with static analysis resulting in a supplemental caller list of candidate callers that are configured to call the designated program.

8. The computer-implemented method of claim 7, wherein the caller list comprises the preliminary caller list combined with the supplemental caller list.

9. The computer-implemented method of claim 1, further comprising:
blocking call requests to the designated program from callers that lack the authorization key.

10. The computer-implemented method of claim 1, further comprising:
requiring, by the designated program, a memory address of a save location of a caller as a condition for completing call requests.

11. A computer program product comprising one or more computer readable storage media, and program instructions collectively stored on the one or more computer readable storage media, the program instructions executable by a processor to cause the processor to perform operations comprising:
generating a caller list of callers that issue requests for calling a designated program at runtime;
generating an authorized caller list of authorized callers allowed to call the designated program, wherein the authorized callers are selected from among callers on the caller list; and
generating an authorization key for each of the authorized callers that the designated program will require as a condition for completing call requests.

12. The computer program product of claim 11, wherein the stored program instructions are stored in a computer readable storage device in a data processing system, and wherein the stored program instructions are transferred over a network from a remote data processing system.

13. The computer program product of claim 11, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

14. The computer program product of claim 11, wherein the generating of the caller list comprises analyzing the designated program with dynamic analysis resulting in a preliminary caller list of detected callers that issue requests for calling the designated program during the dynamic analysis.

15. The computer program product of claim 14, wherein the generating of the caller list further comprises generating a candidate caller list by comparing available programs to detected callers on the caller list and identifying, as candidate callers, available programs that have a preselected characteristic in common with at least one detected caller on the preliminary caller list.

16. The computer program product of claim 15, wherein the generating of the caller list further comprises analyzing the candidate callers on the candidate caller list with static analysis resulting in a supplemental caller list of candidate callers that are configured to call the designated program.

17. A computer system comprising a processor and one or more computer readable storage media, and program instructions collectively stored on the one or more computer readable storage media, the program instructions executable by the processor to cause the processor to perform operations comprising:
generating a caller list of callers that issue requests for calling a designated program at runtime;
generating an authorized caller list of authorized callers allowed to call the designated program, wherein the authorized callers are selected from among callers on the caller list; and
generating an authorization key for each of the authorized callers that the designated program will require as a condition for completing call requests.

18. The computer system of claim 17, wherein the generating of the caller list comprises analyzing the designated program with dynamic analysis resulting in a preliminary caller list of detected callers that issue requests for calling the designated program during the dynamic analysis.

19. The computer system of claim 18, wherein the generating of the caller list further comprises generating a candidate caller list by comparing available programs to detected callers on the caller list and identifying, as candidate callers, available programs that have a preselected characteristic in common with at least one detected caller on the preliminary caller list.

20. The computer system of claim 19, wherein the generating of the caller list further comprises analyzing the candidate callers on the candidate caller list with static analysis resulting in a supplemental caller list of candidate callers that are configured to call the designated program.
